(19) United States
(12) Patent Application Publication
(10) Pub. No.: US 2015/0227234 A1
(43) Pub. Date: Aug. 13, 2015

(54) TOUCH PANEL AND MANUFACTURING METHOD FOR THE SAME, AND DISPLAY DEVICE

(71) Applicants: BOE TECHNOLOGYH GROUP CO., LTD., BEIJING (CN); HEFIE BOE OPTOELECTRONICS TECHNOLOGY CO., LTD., HEFEI, ANHUI (CN)

(72) Inventor: Suzhen Mu, Beijing (CN)

(73) Assignees: BOE TECHNLOGY GROUP CO., LTD., BEIJING (CN); HEFIE BOE OPTOECECTRONICS TECHNOLOGY CO., LTD., HEFEI, ANHUI (CN)

(21) Appl. No.: 14/415,991

(22) PCT Filed: May 20, 2014
(86) PCT No.: PCT/CN2014/077889

§ 371 Date: Jan. 20, 2015

(30) Foreign Application Priority Data
Dec. 9, 2013 (CN) 201310662060.5

(51) Int. Cl. G06F 3/044; G06F 3/041; G06F 1/16

(52) U.S. Cl. CPC G06F 3/044; G06F 1/16; G06F 3/0412; G06F 2203/04111; G06F 2203/04103; G06F 2203/04107

(57) ABSTRACT

The touch panel according to the present disclosure includes a first transparent conductive layer arranged on a substrate, an insulating layer arranged on the first transparent conductive layer, and a second transparent conductive layer arranged on the insulating layer. The first transparent conductive layer includes a first sensing electrode pattern, the second transparent conductive layer includes a second sensing electrode pattern, and the insulating layer is provided with a via-hole at a position corresponding to the second sensing electrode pattern so as to locate a portion of the second sensing electrode pattern within the via-hole.

### CROSS-REFERENCE TO RELATED APPLICATION

This application is the U.S. national phase of PCT Application No. PCT/CN2014/077889 filed on May 20, 2014, which claims priority to Chinese Patent Application No. 201310662060.5 filed on Dec. 9, 2013, the disclosures of which are incorporated in their entirety by reference herein.

### FIELD OF THE INVENTION

The present disclosure relates to the field of display technology, in particular to a touch panel and a manufacturing method for the same, and a display device.

### DESCRIPTION OF THE PRIOR ART

Currently, touch screen is the simplest, most convenient and most natural human-computer interactive device, and as an attractive multimedia interactive device, it gives the multimedia a new appearance and significantly facilitates the people's lives.

A touch function of the touch screen is mainly achieved by a touch panel. As shown in FIGS. 1-4, an existing touch panel includes a plurality of rows of first sensing electrode patterns Rx1 arranged on a substrate in a first direction and a plurality of rows of second sensing electrode patterns Tx2 arranged in a second direction. The first sensing electrode patterns Rx1 each serves as a signal receiving line while the second sensing electrode patterns Tx2 each serves as a signal transmitting line. The first sensing electrode patterns Rx1 and the second sensing electrode patterns Tx2 are separated by an insulating layer, and an inherent capacitance is formed therebetween. After the signal transmitting line transmits a signal, the signal receiving line performs the touch sensing by collecting a voltage signal for the inherent capacitance. If there is a touch from the outside, the inherent capacitance will be incorporated into a touch capacitance with respect to ground, and different voltage signals will be collected by the signal receiving lines. As a result, it is able to determine a position where the touch has been made.

The touch accuracy and anti-interference capability of the touch panel depend on a capacity of the capacitance between a certain signal transmitting line and a certain signal receiving line. However, there is a limited capacitance between a certain signal transmitting line and a certain signal receiving line of the conventional touch panel, so the anti-interference capability of the touch panel is not strong enough.

### SUMMARY OF THE INVENTION

An object of the present disclosure is to provide a touch panel and a manufacturing method for the same, and a display device, so as to increase a capacitance of the touch panel and improve the anti-interference capability thereof.

In one aspect, the present disclosure provides a touch panel, including a first transparent conductive layer arranged on a substrate, an insulating layer arranged on the first transparent conductive layer, and a second transparent conductive layer arranged on the insulating layer. The first transparent conductive layer includes a first sensing electrode pattern, the second transparent conductive layer includes a second sensing electrode pattern, and the insulating layer is provided with a via-hole at a position corresponding to the second sensing electrode pattern so as to locate a portion of the second sensing electrode pattern within the via-hole.

Further, the via-hole may be not in contact with the first sensing electrode pattern.

Further, the touch panel may specifically include:

the first sensing electrode pattern arranged on the substrate and formed by the first transparent conductive layer;

a pattern of the insulating layer arranged on the first sensing electrode pattern and including the via-hole; and

the second sensing electrode pattern arranged on the insulating layer and formed by the second transparent conductive layer.

Further, the first transparent conductive layer may further include a conductive pattern corresponding to the via-hole.

Further, the touch panel may specifically include:

the first sensing electrode pattern and the conductive pattern arranged on the substrate and formed by the first transparent conductive layer;

the pattern of the insulating layer arranged on the first sensing electrode pattern and the conductive pattern and including the via-hole; and

the second sensing electrode pattern arranged on the insulating layer and formed by the second transparent conductive layer, the conductive layer being connected to the second sensing electrode pattern through the via-hole.

In another aspect, the present disclosure provides a display device including any one of the above-mentioned touch panels.

In yet another aspect, the present disclosure provides a method for manufacturing a touch panel, wherein the touch panel includes a first transparent conductive layer arranged on a substrate, an insulating layer arranged on the first transparent conductive layer and a second transparent conductive layer arranged on the insulating layer, the first transparent conductive layer includes a first sensing electrode pattern, and the second transparent conductive layer includes a second sensing electrode pattern. The method includes a step of forming a via-hole in the insulating layer at a position corresponding to the second sensing electrode pattern, so as to locate a portion of the second sensing electrode pattern within the via-hole.

Further, the step of forming the via-hole in the insulating layer at a position corresponding to the second sensing electrode pattern may include:

forming the via-hole in the insulating layer at a position corresponding to the second sensing electrode pattern and not in contact with the first sensing electrode pattern.

Further, the method may specifically include:

depositing the first transparent conductive layer on the substrate, and forming the first sensing electrode pattern by a patterning process;

depositing the insulating layer n the substrate provided with the first sensing electrode pattern, and forming the via-hole in the insulating layer at a position corresponding to the second sensing electrode pattern by a patterning process; and

depositing the second transparent conductive layer on the insulating layer provided with the via-hole, and forming the second sensing electrode pattern by a patterning process.

Further, the method may include:

forming a conductive pattern corresponding to the via-hole by using the first transparent conductive layer.

Further, the method may specifically include:

depositing the first transparent conductive layer on the substrate, and forming the first sensing electrode pattern and the conductive pattern by a patterning process;

depositing the insulating layer on the substrate provided with the first sensing electrode pattern, and forming the via-hole in the insulating layer at a position corresponding to the second sensing electrode pattern by a patterning process; and

depositing the second transparent conductive layer on the insulating layer provided with the via-hole, and forming the second sensing electrode pattern by a patterning process, the conductive pattern being connected to the second sensing electrode pattern through the via-hole.

The present disclosure has the following advantageous effects. According to the present disclosure, the insulating layer between the first sensing electrode pattern and the second sensing electrode pattern is not a complete layer, and the insulating layer is provided with the via-hole at a position corresponding to the second sensing electrode pattern. As a result, it is able to locate a portion of the second sensing electrode pattern within the via-hole, thereby to increase the mutual capacitance between the first sensing electrode pattern and the second sensing electrode pattern, and improve the anti-interference capability of the touch panel.

### BRIEF DESCRIPTION OF THE DRAWINGS

FIG. 1 is a schematic view showing a first sensing electrode pattern and a second sensing electrode pattern of a conventional touch panel;

FIG. 2 is a partial schematic view showing the first sensing electrode pattern and the second sensing electrode pattern of the conventional touch panel;

FIG. 3 is sectional view along line A-A′ in FIG. 2;

FIG. 4 is a sectional view along line B-B′ in FIG. 2;

FIG. 5 is a partial schematic view showing a first sensing electrode pattern and a second sensing electrode pattern of a touch panel according to one embodiment of the present disclosure;

FIG. 6 is a sectional view along A-A′ in FIG. 5 according to one embodiment of the present disclosure;

FIG. 7 is a sectional view along line B-B′ in FIG. 5 according to one embodiment of the present disclosure;

FIG. 8 is a sectional view along line A-A′ in FIG. 5 according to another embodiment of the present disclosure; and

FIG. 9 is a sectional view along line B-B′ in FIG. 5 according to another embodiment of the present disclosure.

### DETAILED DESCRIPTION OF THE PREFERRED EMBODIMENTS

In order to make the objects, the technical solutions and the advantages of the present disclosure more apparent, the present disclosure will be described hereinafter in conjunction with the drawings and the embodiments.

The present disclosure provides a touch panel and a manufacturing method for the same, and a display device, so as to increase a capacitance of the touch panel and improve the anti-interference capability thereof.

The present disclosure provides a touch panel, including a first transparent conductive layer arranged on a substrate, an insulating layer arranged on the first transparent conductive layer, and a second transparent conductive layer arranged on the insulating layer. The first transparent conductive layer includes a first sensing electrode pattern, the second transparent conductive layer includes a second sensing electrode pattern, and the insulating layer is provided with a via-hole at a position corresponding to the second sensing electrode pattern so as to locate a portion of the second sensing electrode pattern within the via-hole.

Different from a conventional touch panel, the insulating layer between the first sensing electrode pattern and the second sensing electrode pattern in the touch panel of the present disclosure is not a complete layer, and it is provided with the via-hole at a position corresponding to the second sensing electrode pattern. As a result, it is able to locate a portion of the second sensing electrode pattern within the via-hole, thereby to increase a mutual capacitance between the first sensing electrode pattern and the second sensing electrode pattern, and improve the anti-interference capability of the touch panel.

The via-hole in the insulating layer is not in contact with the first sensing electrode pattern. In this way, the first sensing electrode pattern will not be in contact with the second sensing electrode pattern through the via-hole, and as a result, the normal operation of the touch panel will not be affected.

To be specific, the touch panel includes:

the first sensing electrode pattern arranged on the substrate and formed by the first transparent conductive layer;

a pattern of the insulating layer arranged on the first sensing electrode pattern and including the via-hole; and

the second sensing electrode pattern arranged on the insulating layer and formed by the second transparent conductive layer, a portion of the second sensing electrode pattern being located within the via-hole.

Further, the first transparent conductive layer further includes a conductive pattern corresponding to the via-hole. In this way, the second sensing electrode pattern is connected to the conductive pattern through the via-hole, so as to form a new conductive structure which has a thickness greater than the second sensing electrode pattern. As a result, it is able to further increase an edge capacitance of the touch panel.

To be specific, the touch panel includes;

the first sensing electrode pattern and the conductive pattern arranged on the substrate and formed by the first transparent conductive layer;

the pattern of the insulating layer arranged on the first sensing electrode pattern and the conductive pattern and including the via-hole; and

the second sensing electrode pattern arranged on the insulating layer and formed by the second transparent conductive layer, the conductive layer being connected to the second sensing electrode pattern through the via-hole.

The present disclosure further provides a display device including the above-mentioned touch panel. The display device may be any display element having a touch function such as a liquid crystal display, an electronic paper and an organic light-emitting diode (OLED), or any product or member including the display element and having a touch function, such as a TV, a digital camera, a mobile phone and a flat panel PC.

The present disclosure further provides a method for manufacturing a touch panel, wherein the touch panel includes a first transparent conductive layer arranged on a substrate, an insulating layer arranged on the first transparent conductive layer and a second transparent conductive layer arranged on the insulating layer, the first transparent conductive layer includes a first sensing electrode pattern, and the second transparent conductive layer includes a second sensing electrode pattern. The method includes a step of forming a via-hole in the insulating layer at a position corresponding to the second sensing electrode pattern, so as to locate a portion of the second sensing electrode pattern within the via-hole.

Different from the conventional touch panel, the insulating layer between the first sensing electrode pattern and the second sensing electrode pattern in the touch panel of the present disclosure is not a complete layer, and it is provided with the via-hole at a position corresponding to the second sensing electrode pattern. As a result, it is able to locate a portion of the second sensing electrode pattern within the via-hole, thereby to increase a mutual capacitance between the first sensing electrode pattern and the second sensing electrode pattern, and improve the anti-interference capability of the touch panel.

Further, the step of forming the via-hole in the insulating layer at a position corresponding to the second sensing electrode pattern includes: forming the via-hole in the insulating layer at a position corresponding to the second sensing electrode pattern and not in contact with the first sensing electrode pattern. In this way, the first sensing electrode pattern will not be connected to the second sensing electrode pattern through the via-hole, and as a result, the normal operation of the touch panel will not be affected.

To be specific, the method includes:

depositing the first transparent conductive layer on the substrate, and forming the first sensing electrode pattern by a patterning process;

depositing the insulating layer n the substrate provided with the first sensing electrode pattern, and forming the via-hole in the insulating layer at a position corresponding to the second sensing electrode pattern by a patterning process; and

depositing the second transparent conductive layer on the insulating layer provided with the via-hole, and forming the second sensing electrode pattern by a patterning process.

The method further includes forming a conductive pattern corresponding to the via-hole using the first transparent conductive layer. In this way, the second sensing electrode pattern is connected to the conductive pattern through the via-hole to form a new conductive structure which has a thickness greater than the second sensing electrode pattern. As a result, it is able to further increase the edge capacitance of the touch panel.

To be specific, the method includes:

depositing the first transparent conductive layer on the substrate, and forming the first sensing electrode pattern and the conductive pattern by a patterning process;

depositing the insulating layer on the substrate provided with the first sensing electrode pattern, and forming the via-hole in the insulating layer at a position corresponding to the second sensing electrode pattern by a patterning process; and

depositing the second transparent conductive layer on the insulating layer provided with the via-hole, and forming the second sensing electrode pattern by a patterning process, the conductive pattern being connected to the second sensing electrode pattern through the via-hole.

The touch panel and its manufacturing method of the present disclosure will be described hereinafter in conjunction with the following embodiments.

### First Embodiment

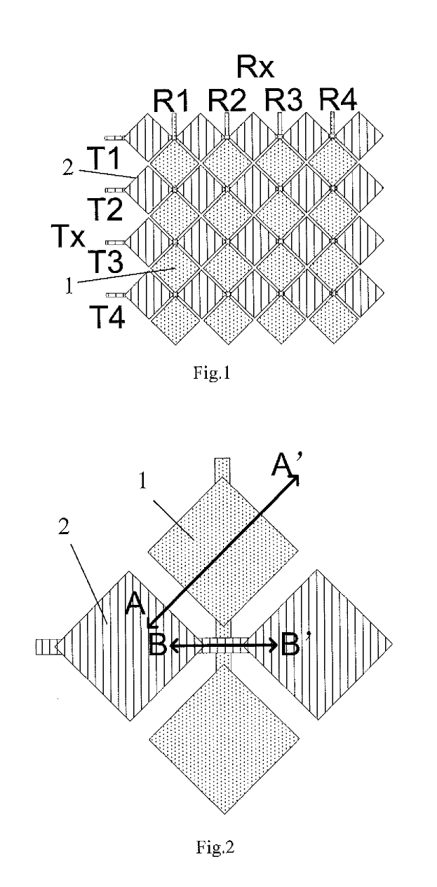

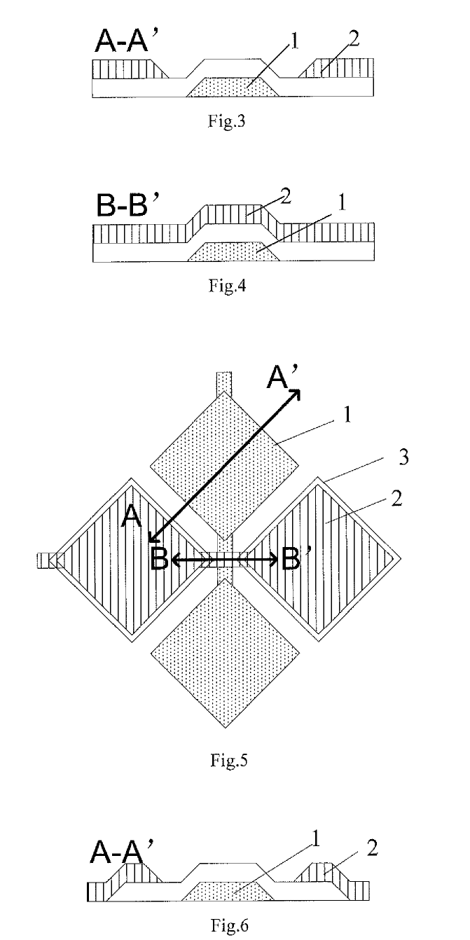

As shown in FIGS. 1-4, in the conventional touch panel, a first sensing electrode pattern 1 is separated from a second sensing electrode pattern 2 by an insulating layer. A mutual capacitance is formed between the first sensing electrode pattern 1 and the second sensing electrode pattern 2 in a direction perpendicular to a substrate, and edge capacitances are formed between the first sensing electrode pattern 1 and the second sensing electrode pattern 2 in other directions. The mutual capacitance and the edge capacitances constitute an inherent capacitance between the first sensing electrode pattern 1 and the second sensing electrode pattern 2. In order to improve the anti-interference capability of the touch panel, in this embodiment, the insulating layer is provided with a via-hole at a position corresponding to the second sensing electrode pattern 2, so as to increase the inherent capacitance between the first sensing electrode pattern 1 and the second sensing electrode pattern 2.

To be specific, the method for manufacturing the touch panel in this embodiment includes the following steps.

Step a: depositing the first transparent conductive layer on the substrate, and forming the first sensing electrode pattern by a patterning process. To be specific, the first transparent conductive layer is formed on the substrate by depositing. The first transparent conductive layer may be made of Indium Tin Oxide (ITO), Indium Zinc Oxide (IZO), Zinc Oxide (ZnO), or Zinc Oxide doped with Aluminum (AZO).

A photoresist is applied onto the first transparent conductive layer, and the resultant first transparent conductive layer is then exposed and developed with a mask. If a positive photoresist is used, a photoresist reserved region after the development corresponds to the first sensing electrode pattern, and the photoresist at other regions is fully removed. A region of the first transparent conductive layer not covered with the photoresist is etched, and the remaining photoresist is removed, so as to form the first sensing electrode pattern using the first transparent conductive layer. Specifically, the region of the first transparent conductive layer not covered with the photoresist may be etched by wet etching, i.e., the region of the first transparent conductive layer not covered with the photoresist may be etched off by an etchant. Of course, a dry etching method may also be used, i.e., the region of the first transparent conductive layer not covered with the photoresist may be etched off by air bombardment.

Step b: depositing the insulating layer on the substrate provided with the first sensing electrode pattern, and forming the via-hole in the insulating layer at a position corresponding to the second sensing electrode pattern by a patterning process. To be specific, the insulating layer may be formed on the substrate with the first sensing electrode pattern by depositing, and the insulating layer may be made of an oxide of N or Si, or SiNx.

A photoresist is applied onto the insulating layer, and the resultant insulating layer is then exposed and developed with a mask. If a negative photoresist is used, a photoresist reserved region after the development corresponds to the second sensing electrode pattern in a direction perpendicular to the substrate, or the photoresist reserved region includes the second sensing electrode pattern but is slightly larger than the second sensing electrode pattern, and the photoresist reserved region after the development does not overlap the first sensing electrode pattern. Then, the photoresist at other regions is fully removed. A region of the insulating layer covered with the photoresist is then etched so as to form the pattern of the insulating layer provided with the via-hole. Specifically, the region of the insulating layer covered with the photoresist may be etched by wet etching, i.e., the region of the insulating layer covered with the photoresist may be etched off by an etchant. Of course, a dry etching method may also be used, i.e., the region of the insulating layer covered with the photoresist may be etched off by air bombardment.

Step c: depositing the second transparent conductive layer on the insulating layer provided with the via-hole, and forming the second sensing electrode pattern by a patterning process. To be specific, the second transparent conductive layer is formed on the insulating layer by depositing. The second transparent conductive layer may be made of ITO or IZO, but it is not limited thereto. For example, the second transparent conductive layer may also be made of ZnO or AZO in accordance with the practical need.

A photoresist is applied onto the second transparent conductive layer, and the resultant second transparent conductive layer is then exposed and developed with a mask. If a positive photoresist is used, a photoresist reserved region after the development corresponds to the second sensing electrode pattern, and the photoresist at other regions is fully removed. A region of the second transparent conductive layer not covered with the photoresist is etched, and the remaining photoresist is removed, so as to form the second sensing electrode pattern using the second transparent conductive layer. Specifically, the region of the second transparent conductive layer not covered with the photoresist may be etched by wet etching, i.e., the region of the second transparent conductive layer not covered with the photoresist may be etched off by an etchant. Of course, a dry etching method may also be used, i.e., the region of the second transparent conductive layer not covered with the photoresist may be etched off by air bombardment.

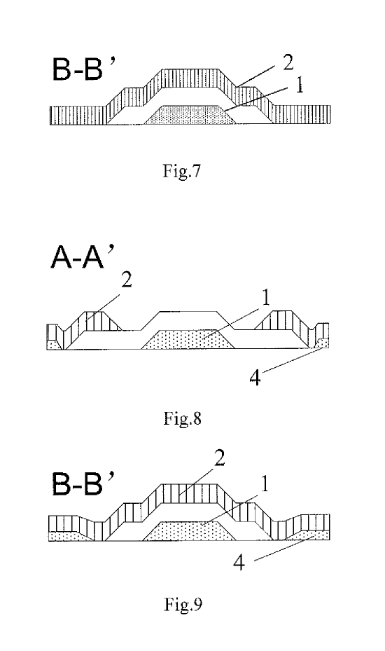

The first sensing electrode pattern 1 and the second sensing electrode pattern 2 as shown in FIGS. 5-7 may be formed through the above steps. In a direction perpendicular to the substrate, the via-hole 3 may fully overlap, or may be slightly larger than, the second sensing electrode pattern 2, but it will not overlap the first sensing electrode pattern 1. It can be seen that, a portion of the second sensing electrode pattern 2 is located within the via-hole 3 in the insulating layer. In this way, the portion of the second sensing electrode pattern 2 is located at a layer identical to the first sensing electrode pattern 1. As a result, it is able to increase the mutual capacitance between the second sensing electrode pattern 2 and the first sensing electrode pattern 1, thereby to increase the inherent capacitance therebetween and improve the anti-interference capability of the touch panel.

The capacitance is simulated by using software named ism. As shown in FIG. 1, pitches between T1 and T2, T2 and T3, and T3 and T4 are each set as 1500 μm, pitches between R1 and R2, R2 and R3, and R3 and R4 are each set as 1500 μm, a length of line A-A′ is set as 60 μm (i.e., a vertical distance from one edge to an opposite edge of a diamond pattern in FIG. 1), a length of line B-B′ is set as 50 μm, and R2 represents a main conductor. Upon calculation, the capacitances between R2 and R1, R2 and R3, T1 and T2, T2 and T3, and T3 and T4 are all 2.23 pF. Then, the via-hole is provided in the insulating layer so as to obtain the structure as shown in FIG. 5. After simulation, the resultant capacitances between R2 and R1, R2 and R3, T1 and T2, T2 and T3, and T3 and T4 are all 2.44 pF, i.e., the capacitances are each increased by 9.4%. Hence, according to the present disclosure, the capacitance between a signal transmitting line and a signal receiving line will be increased by about 10%.

In this embodiment, the signal transmitting line is formed in the via-hole of the insulating layer. Identically, the signal receiving line may also be formed in the via-hole of the insulating layer in accordance with an order of the steps or a signal input mode.

### Second Embodiment

As shown in FIGS. 1-4, in the conventional touch panel, the first sensing electrode pattern 1 is separated from the second sensing electrode pattern 2 by the insulating layer. The mutual capacitance is formed between the first sensing electrode pattern 1 and the second sensing electrode pattern 2 in the direction perpendicular to the substrate, and the edge capacitances are formed therebetween in other directions. The mutual capacitance and the edge capacitances constitute the inherent capacitance between the first sensing electrode pattern 1 and the second sensing electrode pattern 2. In order to improve the anti-interference capability of the touch panel, in this embodiment, the insulating layer is provided with the via-hole at a position corresponding to the second sensing electrode pattern 2, so as to increase the natural capacitance between the first sensing electrode pattern 1 and the second sensing electrode pattern 2.

To be specific, the method for manufacturing the touch panel in this embodiment includes the following steps.

Step a: depositing the first transparent conductive layer on the substrate, and forming the first sensing electrode pattern and the conductive pattern by a patterning process. To be specific, the first transparent conductive layer is formed on the substrate by depositing. The first transparent conductive layer may be made of ITO, IZO, ZnO or AZO.

A photoresist is applied onto the first transparent conductive layer, and the resultant first transparent conductive layer is then exposed and developed with a mask. If a positive photoresist is used, a photoresist reserved region after the development corresponds to the first sensing electrode pattern and the conductive pattern which corresponds to the via-hole in the insulating layer, and the photoresist at other regions is fully removed. A region of the first transparent conductive layer not covered with the photoresist is etched, and the remaining photoresist is removed, so as to form the first sensing electrode pattern and the conductive pattern using the first transparent conductive layer. Specifically, the region of the first transparent conductive layer not covered with the photoresist may be etched by wet etching, i.e., the region of the first transparent conductive layer not covered with the photoresist may be etched off by an etchant. Of course, a dry etching method may also be used, i.e., the region of the first transparent conductive layer not covered with the photoresist may be etched off by air bombardment.

Step b: depositing the insulating layer on the substrate provided with the first sensing electrode pattern, and forming the via-hole in the insulating layer at a position corresponding to the second sensing electrode pattern by a patterning process. To be specific, the insulating layer may be formed on the substrate provided with the first sensing electrode pattern by depositing, and the insulating layer may be made of an oxide of N or Si, or SiNx.

A photoresist is applied onto the insulating layer, and the resultant insulating layer is then exposed and developed with a mask. If a negative photoresist is used, a photoresist reserved region after the development corresponds to the second sensing electrode pattern in a direction perpendicular to the substrate, or the photoresist reserved region after the development includes the second sensing electrode pattern but is slightly larger than the second sensing electrode pattern, and the photoresist reserved region after the development does not overlap the first sensing electrode pattern. Then, the photoresist at other regions is fully removed. A region of the insulating layer covered with the photoresist is then etched so as to form the pattern of the insulating layer provided with the via-hole. Specifically, the region of the insulating layer covered with the photoresist may be etched by wet etching, i.e., the region of the insulating layer covered with the photoresist may be etched off by an etchant. Of course, a dry etching method may also be used, i.e., the region of the insulating layer covered with the photoresist may be etched off by air bombardment.

Step c: depositing the second transparent conductive layer on the insulating layer provided with the via-hole, and forming the second sensing electrode pattern by a patterning process. To be specific, the second transparent conductive layer is formed on the insulating layer by depositing. The second transparent conductive layer may be made of ITO, IZO, ZnO or AZO.

A photoresist is applied onto the second transparent conductive layer, and the resultant second transparent conductive layer is then exposed and developed with a mask. If a positive photoresist is used, a photoresist reserved region after the development corresponds to the second sensing electrode pattern, and the photoresist at other regions is fully removed. A region of the second transparent conductive layer not covered with the photoresist is etched, and the remaining photoresist is removed, so as to form the second sensing electrode pattern using the second transparent conductive layer. Specifically, the region of the second transparent conductive layer not covered with the photoresist may be etched by wet etching, i.e., the region of the second transparent conductive layer not covered with the photoresist may be etched off by an etchant. Of course, a dry etching method may also be used, i.e., the region of the second transparent conductive layer not covered with the photoresist may be etched off by air bombardment.

The first sensing electrode pattern 1 and the second sensing electrode pattern 2 as shown in FIGS. 5, 8 and 9 may be formed through the above steps. In a direction perpendicular to the substrate, the via-hole 3 may fully overlap, or may be slightly larger than, the second sensing electrode pattern 2, but it will not overlap the first sensing electrode pattern 1. It can be seen that, a portion of the second sensing electrode pattern 2 is connected to the conductive pattern 4 through the via-hole 3 in the insulating layer so as to form a new conductive structure, a portion of which is located at a layer identical to the first sensing electrode pattern 1. As a result, it is able to increase the mutual capacitance between the second sensing electrode pattern 2 and the first sensing electrode pattern 1. In addition, the conductive structure has a thickness greater than the second sensing electrode pattern 2, so as to increase the edge capacitance between the second sensing electrode pattern 2 and the first sensing electrode pattern 1. In a word, according to the present disclosure, it is able to increase the inherent capacitance between the second sensing electrode pattern 2 and the first sensing electrode pattern 1, and improve the anti-interference capability of the touch panel.

In this embodiment, the signal receiving line is formed prior to the signal transmitting line. Identically, the signal receiving line may also be formed subsequent to the signal transmitting line in accordance with the order of the steps or the signal input mode.

The above are merely the preferred embodiments of the present disclosure. It should be appreciated that, a person skilled in the art may make further improvements and modifications without departing from the principle of the present disclosure, and these improvements and modifications shall also fall within the scope of the present disclosure.

1. A touch panel, comprising a first transparent conductive layer arranged on a substrate, an insulating layer arranged on the first transparent conductive layer, and a second transparent conductive layer arranged on the insulating layer, wherein the first transparent conductive layer includes a first sensing electrode pattern, the second transparent conductive layer includes a second sensing electrode pattern, and the insulating layer is provided with a via-hole at a position corresponding to the second sensing electrode pattern so as to locate a portion of the second sensing electrode pattern within the via-hole.

2. The touch panel according to claim 1, wherein the via-hole is not in contact with the first sensing electrode pattern.

3. The touch panel according to claim 2, wherein the touch panel comprises:
the first sensing electrode pattern arranged on the substrate and formed by the first transparent conductive layer;
a pattern of the insulating layer arranged on the first sensing electrode pattern and including the via-hole; and
the second sensing electrode pattern arranged on the insulating layer and formed by the second transparent conductive layer.

4. The touch panel according to claim 2, wherein the first transparent conductive layer further includes a conductive pattern corresponding to the via-hole.

5. The touch panel according to claim 3, wherein the first transparent conductive layer further includes a conductive pattern corresponding to the via-hole.

6. The touch panel according to claim 4, wherein the touch panel comprises:
the first sensing electrode pattern and the conductive pattern both arranged on the substrate and formed by the first transparent conductive layer;
the pattern of the insulating layer arranged on the first sensing electrode pattern and the conductive pattern and including the via-hole; and
the second sensing electrode pattern arranged on the insulating layer and formed by the second transparent conductive layer, the conductive layer being connected to the second sensing electrode pattern through the via-hole.

7. The touch panel according to claim 5, wherein the touch panel comprises:
the first sensing electrode pattern and the conductive pattern both arranged on the substrate and formed by the first transparent conductive layer;
the pattern of the insulating layer arranged on the first sensing electrode pattern and the conductive pattern and including the via-hole; and
the second sensing electrode pattern arranged on the insulating layer and formed by the second transparent conductive layer, the conductive layer being connected to the second sensing electrode pattern through the via-hole.

8. A display device comprising a touch panel wherein the touch panel comprises a first transparent conductive layer arranged on a substrate, an insulating layer arranged on the first transparent conductive layer, and a second transparent conductive layer arranged on the insulating layer, wherein the first transparent conductive layer includes a first sensing electrode pattern, the second transparent conductive layer includes a second sensing electrode pattern, and the insulating layer is provided with a via-hole at a position corresponding to the second sensing electrode pattern so as to locate a portion of the second sensing electrode pattern within the via-hole.

9. The display device according to claim 8, wherein the via-hole is not in contact with the first sensing electrode pattern.

10. The display device according to claim 9, wherein the touch panel comprises:
the first sensing electrode pattern arranged on the substrate and formed by the first transparent conductive layer;
a pattern of the insulating layer arranged on the first sensing electrode pattern and including the via-hole; and
the second sensing electrode pattern arranged on the insulating layer and formed by the second transparent conductive layer.

11. The display device according to claim 9, wherein the first transparent conductive layer further includes a conductive pattern corresponding to the via-hole.

12. The display device according to claim 10, wherein the first transparent conductive layer further includes a conductive pattern corresponding to the via-hole.

13. The display device according to claim 11, wherein the touch panel comprises:
the first sensing electrode pattern and the conductive pattern both arranged on the substrate and formed by the first transparent conductive layer;
the pattern of the insulating layer arranged on the first sensing electrode pattern and the conductive pattern and including the via-hole; and
the second sensing electrode pattern arranged on the insulating layer and formed by the second transparent conductive layer, the conductive layer being connected to the second sensing electrode pattern through the via-hole.

14. The display device according to claim 12, wherein the touch panel comprises:
the first sensing electrode pattern and the conductive pattern both arranged on the substrate and formed by the first transparent conductive layer;
the pattern of the insulating layer arranged on the first sensing electrode pattern and the conductive pattern and including the via-hole; and
the second sensing electrode pattern arranged on the insulating layer and formed by the second transparent conductive layer, the conductive layer being connected to the second sensing electrode pattern through the via-hole

15. A method for manufacturing a touch panel, the touch panel comprising a first transparent conductive layer arranged on a substrate, an insulating layer arranged on the first transparent conductive layer and a second transparent conductive layer arranged on the insulating layer, wherein the first transparent conductive layer includes a first sensing electrode pattern, and the second transparent conductive layer includes a second sensing electrode pattern, the method comprising a step of forming a via-hole in the insulating layer at a position corresponding to the second sensing electrode pattern, so as to locate a portion of the second sensing electrode pattern within the via-hole.

16. The method according to claim 15, wherein the step of forming the via-hole in the insulating layer at a position corresponding to the second sensing electrode pattern comprises:
forming the via-hole in the insulating layer at a position corresponding to the second sensing electrode pattern and not in contact with the first sensing electrode pattern.

17. The method according to claim 16, wherein the method comprises:
depositing the first transparent conductive layer on the substrate, and forming the first sensing electrode pattern by a patterning process;
depositing the insulating layer on the substrate provided with the first sensing electrode pattern, and forming the via-hole in the insulating layer at a position corresponding to the second sensing electrode pattern by a patterning process; and
depositing the second transparent conductive layer on the insulating layer provided with the via-hole, and forming the second sensing electrode pattern by a patterning process.

18. The method according to claim 16, further comprising:
forming a conductive pattern corresponding to the via-hole by using the first transparent conductive layer.

19. The method according to claim 17, further comprising:
forming a conductive pattern corresponding to the via-hole by using the first transparent conductive layer.

20. The method according to claim 18, wherein the method comprises:
depositing the first transparent conductive layer on the substrate, and forming the first sensing electrode pattern and the conductive pattern by a patterning process;
depositing the insulating layer on the substrate provided with the first sensing electrode pattern, and forming the via-hole in the insulating layer at a position corresponding to the second sensing electrode pattern by a patterning process; and
depositing the second transparent conductive layer on the insulating layer provided with the via-hole, and forming the second sensing electrode pattern by a patterning process, the conductive pattern being connected to the second sensing electrode pattern through the via-hole.
